(19) United States
(12) Patent Application Publication
(10) Pub. No.: US 2011/0039976 A1
(43) Pub. Date: Feb. 17, 2011

(54) Tire having a Tread Provided with Cavities Containing a Specific Filling Material

(75) Inventor: Didier Vasseur, Clermont- Ferrand (FR)

Correspondence Address: COHEN, PONTANI, LIEBERMAN & PAVANE LLP, 551 FIFTH AVENUE, SUITE 1210, NEW YORK, NY, 10176, US

(73) Assignees: Societe De Technologie Michelin, Clemont-Ferrand (FR); Michelin Recherche et Technique S.A., Granges Paccot (CH)

(21) Appl. No.: 12/810,982

(22) PCT Filed: Dec. 18, 2008
(86) PCT No.: PCT/EP08/10791

§ 371 Date: Nov. 3, 2010

(30) Foreign Application Priority Data
Dec. 28, 2007 (FR) 0760442

(51) Int. Cl. C08K 3/04; C08K 3/26

(52) U.S. Cl. 523/155

(57) ABSTRACT

A tire having a tread, said tread being provided with a plurality of cavities, at least some of said cavities having a filling composition based on at least: a diene elastomer; more than 50 phr of filler (denoted filler A), the particles of which are nanoparticles having an average size (by weight) of less than 500 nm; and more than 70 phr of filler (denoted filler B), the particles of which are microparticles having a median particle size (by weight) of greater than 1 μm. This filling composition is sufficiently cohesive to ensure excellent mechanical behaviour of the cavities. It also has the capability of progressively wearing during running, without cracking, more quickly than the constituent composition of the tread itself.

The present invention relates to tires, to the treads of these tires and to rubber compositions that can be used for manufacturing these treads.

The invention relates more particularly to compositions (also called hereafter “filling materials”) that can be used to fill cavities present on the surface of the treads in the unworn state, or else incorporated into the bulk of said treads and intended to be flush with their surface at a subsequent stage, after running for a first time.

As is known, the tread of a tire, whether intended for fitting onto a passenger vehicle or a heavy-goods vehicle, is provided with a tread pattern for obtaining satisfactory grip performance, in particular on ground made slippery by the presence of a liquid. Such a tread pattern especially comprises tread pattern elements or elementary blocks formed by moulding in the thickness of the tread, which are bounded by various main, longitudinal, transverse or even oblique, ribs or grooves, it being possible for these elementary blocks to also include various incisions or thinner strips.

The use of a filling material in the treads of tires, in order to fill various cavities such as in particular the above ribs, grooves or incisions, has already been described in many documents.

For example, it is known to provide main circumferential ribs or transverse grooves of the tread with a filling material having a lower abrasion resistance than the composition of the tread itself, in order to improve tread grip, to reduce noise or to eradicate ozone-induced attack at the bottom of the grooves (see for example documents FR 652 077, GB 506 142, and DE 36 10 662).

Patent Application EP 1 065 075 was proposed for providing the tread pattern blocks with a plurality of fine incisions, which do not open onto the surface of the tread, said incisions containing a filling material that wears away more quickly than the composition of the tread itself (see in particular FIGS. 1 and 2 of the application). The filling material is bonded, during vulcanization, to the walls defining each incision. At least in the unworn state, said material completely fills the cavity and mechanically connects the walls of the cavity thus filled, thereby enabling the tread pattern elements to maintain rigidity. Under the action of frictional contact with the ground when the tire is running, the filling material is progressively removed, more rapidly than the constituent composition of the tread (referred to as differential wear), in order to form a very shallow channel, the depth of which is however sufficient to allow some of the air trapped in the “blind” incisions to escape, thus preventing the running noise of the tire provided with such a tread from increasing.

However, the filling materials used may have drawbacks. Depending on the particular running conditions of the tire, there may be a tendency for the material to crack during running, resulting in a partial loss of cohesion of the material (the cavities then have a tendency to suddenly empty) which in the end is prejudicial to the intended differential (progressive) wear as described above.

By continuing their research, the Applicants have discovered rubber compositions which, by combining high levels of reinforcing filler and of non-reinforcing filler, are particularly useful as filling material.

Thus, a primary subject of the invention is a tire having a tread, said tread being provided with a plurality of cavities, at least some of said cavities having a filling composition based on at least:
a diene elastomer;
more than 50 phr of filler (denoted filler A), the particles of which are nanoparticles having an average size (by weight) of less than 500 nm; and
more than 70 phr of filler (denoted filler B), the particles of which are microparticles having a median particle size (by weight) of greater than 1 μm.

Unexpectedly, the filling composition is sufficiently cohesive to ensure excellent mechanical behaviour of the (at least partly) filled cavities. It also has the capability of progressively wearing during running, without cracking, more quickly than the constituent composition of the tread itself.

The term “cavity” is understood in the present application to mean any cut-out or notch, whether continuous or discontinuous, bounded by at least one wall and a bottom, the width of which is small relative to the dimensions of the tread pattern blocks or elements, said cavity having any orientation with respect to the longitudinal (i.e. circumferential) direction of the tread. This may for example be a main rib having two walls extending continuously over the entire circumference of the tread, a main or auxiliary groove separating at least two adjacent tread pattern blocks, or a much finer incision, typically with a width of less than 2 mm, present inside an elementary block of the tread pattern. Depending on the desired effect, this cavity has a depth which varies according to the thickness of the tread itself.

The invention and its advantages will be readily understood in the light of the description and illustrative examples that follow.

### I—MEASUREMENTS AND TESTS USED

The filling compositions are characterized, before and after curing, as indicated below.

### I.1—Characterization of the Fillers

The average size (by weight) of the nanoparticles, denoted by d_{w}, is conventionally measured after dispersion, by ultrasonic deagglomeration, of the filler to be analysed in water or an aqueous solution containing a surfactant.

For an inorganic filler such as silica, the measurement is carried out by means of an XDC (X-ray disk centrifuge) X-ray centrifugal sedimentometer, sold by the company Brookhaven Instruments according to the following operating method. A suspension consisting of 3.2 g of inorganic filler specimen to be analysed in 40 ml of water is formed by operating a 1500 W ultrasound probe (¾ inch Vibracell sonicator sold by the company Bioblock) for 8 minutes at 60% power (i.e. 60% away from the maximum “output control” position). After sonification, 15 ml of the of suspension are introduced into the rotating disk. After sedimentation for 120 minutes, the weight distribution of the particle sizes and the weight-average size of the particles d_{w} are calculated by the XDC sedimentometer software (d_{w}=Σ(nᵢdᵢ⁵)/Σ(nᵢdᵢ⁴) in which nᵢ is the number of objects of the size or diameter class dᵢ).

For carbon black, this procedure is carried out with an aqueous solution comprizing 15 vol % of ethanol and 0.05 vol % of a nonionic surfactant. The determination is accomplished by means of a centrifugal photosedimentometer of the DCP type (disk centrifuge photosedimentometer, sold by the company Brookhaven Instruments). A suspension comprizing 10 mg of carbon black is formed beforehand in 40 ml of an aqueous solution comprizing 15 vol % of ethanol and 0.05 vol % of a nonionic surfactant, by operating a 600 W ultrasound probe (½ inch Vibracell sonicator sold by the company Bioblock) for 10 minutes at 60% power (i.e. at 60% of the maximum position of the “tip amplitude”). During sonification, a gradient composed of 15 ml of water (containing 0.05% of a nonionic surfactant) and 1 ml of ethanol is injected into the sedimentometer disk rotating at 8000 rpm so as to form a “step gradient”. Next, 0.3 ml of the carbon black suspension is injected onto the surface of the gradient. After sedimentation lasting 120 minutes, the mass distribution of the particle sizes and the weight-average size d_{w} are calculated by the sedimentometer software as indicated above.

As regards measuring the size of the microparticles (i.e. the non-reinforcing particles), a particle size analysis may be simply used by mechanical screening. The operation consists in screening a defined quantity (for example 200 g) of specimen on a vibrating table for 30 minutes with different screen diameters (for example with a series of 10 to 15 meshes varying progressively from 5 to 300 μm in size). The oversize collected on each screen is weighed on a precision balance, and deduced from this is the % oversize for each mesh diameter relative to the total weight of product, and the median size by weight (or apparent median diameter) is finally calculated in a known manner from the histogram of the particle size distribution.

### I.2—Tensile Tests

These tests are used to determine the elastic stresses and failure properties. Unless otherwise indicated, they are carried out in accordance with French Standard NF T 46-002 of September 1988. The nominal secant moduli (or apparent stresses, in MPa) at 10% elongation (denoted by MA10) are measured in a second elongation (i.e. after an accommodating cycle at the degree of extension intended for the measurement itself). The elongations at break (AR in %) are also measured. All these tensile measurements are carried out under normal temperature (23±2° C.) and moisture (50±5% relative humidity) conditions according to the French Standard NF T 40-101 (December 1979).

### I.3—Shore A Hardness

The Shore A hardness of the compositions after curing is determined in accordance with the ASTM D 2240-86 Standard.

### I.4—Tire Running Tests

All the tire running tests are carried out on wet ground (covered with a continuous film of water 2 mm in thickness), of the polished concrete type.

### A—Straight-Line Running Tests

A.1—Braking with an ABS System

In this first series of tests, the tires contain cavities, the main direction of which lies either in the transverse direction or in the longitudinal direction of the tread on the tire.

The tires are mounted on a motor vehicle fitted with an ABS braking system and the distance necessary for going from a speed of 50 km/h to a speed of 10 km/h when maximum braking is applied is measured. A value greater than the reference value, arbitrarily set at 100, indicates an improved result, i.e. a shorter braking distance.

A.2—Braking with Locked Wheels

Only tires containing cavities with their main direction lying along the transverse direction of the tread on the tire are characterized according to this test.

The grip of the tires is also determined by measuring the braking distances in what is called “two locked wheels” braking mode, i.e. in the absence of an ABS system. The braking distance going from a speed of 40 km/h to a speed of 0 km/h on wet ground is measured. A value greater than the control value, arbitrarily set at 100, indicates an improved result, i.e. a shorter braking distance.

### B—Running Tests on a Circular Track

In this second series of tests, the tires contain cavities having their main direction lying in the longitudinal (or circumferential) direction of the tread. The tires are tested on a circuit in the form of a circular track with a radius of about 120 m.

The transverse grip factor, which, as is known, is the ratio of the transverse force between the ground and the tire to the load of the tire on the ground, is measured. A value greater than the control value, arbitrarily set at 100, indicates an improved result, i.e. a higher transverse grip.

### II—INVENTION OPERATING CONDITIONS

The composition for filling the cavities of the tire tread according to the invention is based on at least the following: a diene elastomer, a reinforcing filler denoted by A and a non-reinforcing filler denoted by B, which fillers will be described in detail later on.

The expression “composition based on” should be understood to mean a composition comprizing the blend of the various constituents used and/or the reaction product resulting therefrom, some of these base constituents being able, or intended, to react, at least partly, with one another during the various phases for manufacturing the composition, in particular during the crosslinking or vulcanization thereof.

In the present description, unless expressly indicated otherwise, all the percentages (%) are % by weight. Moreover, any interval of values denoted by the expression “between a and b” represents the range of values going from more than a to less than b (i.e. the limits a and b being excluded), whereas any interval of values denoted by the expression “from a to b” means the range of values going from a to b (i.e. including the strict limits a and b).

### II.1—Diene Elastomer

The term “diene” elastomer or rubber must be understood, as is known, to mean an elastomer (or several elastomers) at least partly resulting from diene monomers (monomers having two carbon-carbon double bonds, whether conjugated or not), i.e. a homopolymer or a copolymer.

The diene elastomer of the filling composition is preferably selected from the group of highly unsaturated diene elastomers formed: by polybutadienes (BR), synthetic polyisoprenes (IR), natural rubber (NR), butadiene copolymers, isoprene copolymers and blends of these elastomers. Such copolymers are more preferably selected from the group formed by butadiene-styrene (SBR) copolymers, butadiene-isoprene (BIR) copolymers, styrene-isoprene (SIR) copolymers and styrene-butadiene-isoprene (SBIR) copolymers.

Particularly suitable are polybutadienes having a content (in mol %) of -1,2 units between 4% and 80% or those having a cis-1,4 content (in mol %) greater than 80%, polyisoprenes, butadiene-styrene copolymers and in particular those having a T_{g} (glass transition temperature, measured according to ASTM D3418) of between 0° C. and −70° C. and more particularly between −10° C. and −60° C., a styrene content between 5% and 60% by weight, more particularly between 20% and 50% by weight, a content (in mol %) of -1,2 bonds of the butadiene part between 4% and 75% and a content (in mol %) of trans-1,4 bonds between 10% and 80%, butadiene-isoprene copolymers and especially those having an isoprene content between 5% and 90% by weight and a T_{g} ranging from −40° C. to −80° C., and isoprene-styrene copolymers, especially those having a styrene content between 5% and 50% by weight and a T_{g} between −25° C. and −50° C.

In the case of butadiene-styrene-isoprene copolymers, suitable ones are especially those having a styrene content between 5% and 50% by weight and more particularly between 10% and 40% by weight, an isoprene content between 15% and 60% by weight and more particularly between 20% and 50% by weight, a butadiene content between 5% and 50% by weight, and more particularly between 20% and 40% by weight, a content (in mol %) of -1,2 units of the butadiene part of between 4% and 85%, a content (in mol %) of trans-1,4 units of the butadiene part between 6% and 80%, a content (in mol %) of -1,2 plus -3,4 units of the isoprene part between 5% and 70% and a content (in mol %) of trans-1,4 units of the isoprene part between 10% and 50%, and more generally any butadiene-styrene-isoprene copolymer having a T_{g} between −20° C. and −70° C.

According to one particular embodiment, the diene elastomer is predominantly (i.e. more than 50 phr) an SBR, whether an SBR prepared in emulsion (an ESBR) or an SBR prepared in solution (an SSBR), or else an SBR/BR, SBR/NR (or SBR/IR), BR/NR (or BR/IR) blend or an SBR/BR/NR (or SBR/BR/IR) blend. In the case of an SBR elastomer (whether an ESBR or an SSBR), an SBR having a moderate styrene content, for example between 20% and 35% by weight, or a high styrene content, for example 35 to 45%, a content of vinyl bonds of the butadiene part between 15% and 70%, a content (in mol %) of trans-1,4 bonds between 15% and 75% and a T_{g} between −10° C. and −55° C. is especially used. Such an SBR may advantageously be used blended with a BR preferably having more than 90 mol % of cis-1,4 bonds.

According to another particular embodiment, the diene elastomer is predominantly (more than 50 phr) an isoprene elastomer. The term “isoprene elastomer” is understood to mean, as is known, either an isoprene homopolymer or an isoprene copolymer, in other words a diene elastomer selected from the group formed by natural rubber (NR), synthetic polyisoprenes (IR), various isoprene copolymers and blends of these elastomers. Among isoprene copolymers, mention may in particular be made of isobutene-isoprene (butyl rubber—IIR) copolymers, styrene-isoprene (SIR) copolymers, butadiene-isoprene (BIR) copolymers and styrene-butadiene-isoprene (SBIR) copolymers. This isoprene elastomer is preferably natural rubber of a synthetic cis-1,4 polyisoprene. Among these synthetic polyisoprenes, it is preferred to use polyisoprenes having a content (in mol %) of cis-1,4 bonds greater than 90%, more preferably still greater than 98%.

According to another preferred embodiment of the invention, the filling composition comprises a blend of one (or more) “high-T_{g}” diene elastomers having a T_{g} between −70° C. and 0° C. and one (or more) “low-T_{g}” diene elastomers having a T_{g} between −110° C. and −80° C., more preferably between −105° C. and −90° C. The high-T_{g} elastomer is preferably selected from the group formed by S-SBR elastomers, E-SBR elastomers, natural rubber, synthetic polyisoprenes (having a content (in mol %) of cis-1,4 links preferably greater than 95%), BIR elastomers, SIR elastomers, SBIR elastomers and blends of these elastomers. The low-T_{g} elastomer preferably comprises butadiene units with a content (in mol %) of at least 70%. Preferably, it consists of a polybutadiene (BR) having a content (in mol %) of cis-1,4 links of greater than 90%.

According to another particular embodiment of the invention, the filling composition comprises for example 30 to 100 phr, particularly 50 to 100 phr, of a high-T_{g} elastomer blended with 0 to 70 phr, particularly 0 to 50 phr, of a low-T_{g} elastomer. According to another example, the composition comprises, for all of the 100 phr, one or more SBR elastomers prepared in solution.

According to another particular embodiment of the invention, the diene elastomer of the filling composition comprises a blend of a BR (as low-T_{g} elastomer) with a content (in mol %) of cis-1,4 links greater than 90%, with one or more S-SBR or E-SBR elastomers (as high-T_{g} elastomer(s)).

The compositions formulated according to the invention may contain a single diene elastomer or a blend of several diene elastomers, it being possible for the diene elastomer or elastomers to be used in combination with any type of synthetic elastomer other than a diene elastomer, or even with polymers other than the elastomers, for example thermoplastic polymers.

### II.2—Filler A

A first essential characteristic of the filling composition is to comprise, as reinforcing filler (denoted by filler A), more than 50 phr of nanoparticles with an average size (by weight) of less than 500 nm.

Any type of reinforcing filler known for its capability of reinforcing a rubber composition that can be used for manufacturing tire treads may be employed, for example an organic filler such as carbon black, a reinforcing inorganic filler, such as silica, or a blend of these two types of filler, especially a carbon black/silica blend.

As carbon blacks, all carbon blacks, especially blacks of the HAF, ISAF and SAF types that are conventionally used in tire treads (referred to as tire-grade blacks) are suitable. Among such blacks, the following may more particularly be mentioned: reinforcing carbon blacks of the 100, 200 or 300 series (ASTM grades), such as for example the blacks N115, N134, N234, N326, N330, N339, N347 and N375. The carbon blacks could for example have already been incorporated into the isoprene elastomer in the form of a masterbatch (see for example Patent Applications WO 97/36724 or WO 99/16600).

As examples of organic fillers other than carbon blacks, mention may be made of functionalized polyvinyl aromatic organic fillers as described in Patent Applications WO-A-2006/069792 and WO-A-2006/069793.

The term “reinforcing inorganic filler” should be understood in the present application to mean, by definition, any inorganic or mineral filler, whatever its colour and its origin (natural or synthetic), also called a “white” filler, a “light” filler or even a “non-black” filler as opposed to carbon black, capable by itself of reinforcing, without means other than an intermediate coupling agent, a rubber composition intended for the manufacture of tires, in other words capable of replacing, in its reinforcing function, a conventional tire-grade carbon black. Such a filler is generally characterized, as is known, by the presence of hydroxyl (—OH) groups on its surface.

The reinforcing inorganic filler may be in any physical state, i.e. in the form of powder, microspheres, granules, beads or any other appropriate densified form. Of course, it is understood that reinforcing inorganic fillers also include mixtures of various reinforcing inorganic fillers, in particular highly dispersible siliceous and/or aluminous fillers as described below.

Suitable reinforcing inorganic fillers are in particular mineral fillers of the siliceous type, particularly silica (SiO₂), or of the aluminous type, in particular alumina (Al₂O₃). The silica used may be any reinforcing silica known to those skilled in the art, especially any precipitated or pyrogenic silica having a BET surface area and a CTAB specific surface area that are both less than 450 m²/g, preferably ranging from 30 to 400 m²/g. As highly dispersible precipitated silicas (“HDS”), the following may for example be mentioned: the silicas Ultrasil 7000 and Ultrasil 7005 from Degussa; the silicas Zeosil 1165MP, 1135MP and 1115MP from Rhodia; the silica Hi-Sil EZ150G from PPG; the silicas Zeopol 8715, 8745 and 8755 from Huber; and silicas having a high specific surface area as described in the Patent Application WO 03/16837.

The reinforcing inorganic filler used, in particular when it is silica, preferably has a BET surface area of between 45 and 400 m²/g, more preferably between 60 and 300 m²/g.

Preferably, the total content of reinforcing filler A (carbon black and/or reinforcing inorganic filler such as silica) is between 50 and 200 phr, more preferably between 60 and 140 phr, and even more preferably between 70 and 130 phr, the optimum being, as is known, different depending on the intended particular applications. The expected level of reinforcement on a cycle tire, for example, is of course lower than that required on a tire capable of running at high speed in a sustained manner, for example a motor cycle tire, a tire for a passenger vehicle or for a utility vehicle such as a heavy-goods vehicle.

According to a preferred embodiment of the invention, a reinforcing filler comprizing between 50 and 150 phr, more preferably between 50 and 120 phr of an inorganic filler, particularly silica, and optionally carbon black is used. The carbon black, when it is present, is preferably used with a content of less than 20 phr, more preferably less than 10 phr (for example between 0.1 and 10 phr).

Preferably, the average size (by weight) of the nanoparticles is between 20 and 200 nm, more preferably between 20 and 150 nm.

To couple the reinforcing inorganic filler to the diene elastomer, it is known to use an at least difunctional coupling agent (or bonding agent) intended to ensure sufficient connection, of chemical and/or physical nature, between the inorganic filler (the surface of its particles) and the diene elastomer, particularly difunctional organosilanes or polyorganosiloxanes.

Polysulphide-containing silanes, which are either “symmetrical” or “asymmetrical” depending on their particular structure, such as those described for example in Patent Applications WO 03/002648 (or US 2005/016651) and WO 03/002649 (or US 2005/016650), may especially be used.

Particularly suitable, without the definition below being limiting, are what are called “symmetrical” polysulphide-containing silanes satisfying the following general formula (I):

Z-A-Sₓ-A-Z, (I)

in which:
x is an integer from 2 to 8 (preferably from 2 to 5);
A is a divalent hydrocarbon radical (preferably C₁-C₁₈ alkylene groups or C₆-C₁₂ arylene groups, more particularly C₁-C₁₀, especially C₁-C₄, alkylene groups, particularly propylene); and
Z satisfies one of the formulae below:

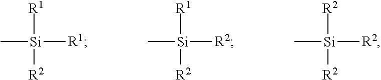

in which:
the radicals R¹, whether substituted or unsubstituted, whether the same or different, represent a C₁-C₁₈ alkyl group, a C₅-C₁₈ cycloalkyl group or a C₆-C₁₈ aryl group (preferably C₁-C₆ alkyl group, cyclohexyl or phrnyl groups, especially C₁-C₄ alkyl groups, more particularly methyl and/or ethyl); and
the radicals R², whether substituted or unsubstituted, whether the same or different, represent a C₁-C₁₈ alkoxy or C₅-C₁₈ cycloalkoxy group (preferably a group selected from C₁-C₈ alkoxy and C₅-C₈ cycloalkoxy groups, more particularly still a group selected from C₁-C₄ alkoxy groups, particularly methoxy and ethoxy groups).

As examples of polysulphide-containing silanes, mention may more particularly be made of bis(3-trimethoxysilylpropyl) polysulphides or bis(3-triethoxysilylpropyl) polysulphides.

Among these compounds, bis(3-triethoxysilylpropyl) tetrasulphide, abbreviated to TESPT, or bis-(triethoxysilylpropyl) disulphide, abbreviated to TESPD, may in particular be used. Mention may also be made, as preferential examples, of bis-((C₁-C₄)monoalkoxyl-(C₁-C₄)dialkylsilylpropyl)polysulphides (especially disulphides, trisulphides or tetrasulphides), more particularly bis(monoethoxydimethylsilylpropyl) tetrasulphide as described in Patent Application WO 02/083782 (or US 2004/132880).

As coupling agent other than a polysulphide-containing alkoxysilane, mention may in particular be made of difunctional POS (polyorganosiloxane) compounds or hydroxysilane polysulphides (R²═OH in formula I above) as described in Patent Applications WO 02/30939 (or U.S. Pat. No. 6,774,255) and WO 02/31041 (or US 2004/051210), or else silanes or PUS compounds carrying azo-dicarbonyl functional groups, as described for example in Patent Applications WO 2006/125532, WO 2006/125533, WO 2006/125534.

In the rubber compositions formulated in accordance with the invention, the coupling agent content is preferably between 4 and 12 phr, more preferably between 3 and 8 phr.

A person skilled in the art will understand that, as equivalent filler to the reinforcing inorganic filler described in the present paragraph, a reinforcing filler of another, especially organic, nature could be used provided that this reinforcing pillar is coated with an inorganic layer, such as a silica layer, or else it includes functional, especially hydroxyl, sites on its surface that require the use of a coupling agent in order to establish the bonding between the filler and the elastomer.

### II.3—Filler B

A second essential characteristic of the filling composition is to consist, as non-reinforcing filler (denoted by filler B), of more than 70 phr of microparticles having an average size (by weight) of greater than 1 μm.

Below the above minima, as regards both the content and the size of the microparticles, the intended technical effect is not obtained. There is then insufficient wear of the filling material, and the filled cavity does not empty sufficiently quickly.

The content of microparticles is preferably greater than 100 phr, more preferably between 100 and 500 phr, and their median size is preferably between 1 and 200 μm, more particularly between 5 and 100 μm. Above the indicated maxima, with regards content and size of the microparticles, there is a risk of the filling composition losing cohesion and of crack initiation therein.

For all the reasons indicated above, the content of microparticles is more preferably between 100 and 300 phr and their median size is more preferably between 10 and 50 μm.

The non-reinforcing fillers that can be used as filler B are known to those skilled in the art, among which in particular the following may be mentioned:
natural calcium carbonates (chalk) or synthetic calcium carbonates, natural silicates (kaolin, talc, mica), ground silicas, aluminas, silicates and aluminosilicates;
biodegradable compounds, such as a polyester amide, starch, polylactic acid, cellulose derivatives (for example cellulose acetate, lignin).

More preferably, microparticles of filler B selected from the group formed by chalk, synthetic calcium carbonates, kaolin and mixtures of such compounds are used.

As examples of such preferred fillers B that are commercially available, mention may for example be made of the chalk sold under the name “Omya BLS” by the company Omya and the kaolins sold under the name “Polwhite KL” by the company Imerys.

### II.4—Various Additives

The filling compositions may also contain some or all of the usual additives customarily used in elastomer compositions intended for the manufacture of tires, such as for example pigments, protection agents, such as antiozone waxes, chemical antiozonants and antioxidants, anti-fatigue agents, reinforcing resins, methylene acceptors (for example novalac phrnolic resin) or methylene donors (for example HMT or H3M) as described for example in Patent Application WO 02/10269, a crosslinking system either based on sulphur or based on sulphur donors and/or on peroxides and/or bismaleimides, vulcanization accelerators and vulcanization activators.

These filling compositions may also contain, in addition to the coupling agents, coupling activators, covering agents for the inorganic fillers or more generally processing aids that are capable, as is known, thanks to an improvement in the dispersion of the filler in the rubber matrix and to a lowering in the viscosity of the compositions, of improving their processibility in the green state, these agents being for example hydrolysable silanes, such as alkylalkoxy silanes, polyols, polyethers, primary, secondary or tertiary amines and hydroxylated or hydrolysable polyorganosiloxanes.

The filling compositions may also include, as preferential non-aromatic or very weakly aromatic plasticizing agent, at least one compound selected from the group formed by naphthenic or paraffinic oils, MES oils, TDAE oils, ester plasticizers (for example glycerol trioleates), hydrocarbon resins having a high T_{g}, preferably greater than 30° C., such as those described for example in Patent Applications WO 2005/087859, WO 2006/061064 and WO 2007/017060, and mixtures of such compounds. The overall content of such a preferential plasticizing agent is preferably between 10 and 100 phr, more preferably between 20 and 80 phr and especially in a range from 10 to 50 phr.

Among the above hydrocarbon plasticizing resins (it is recalled that the term “resin” is by definition reserved for a solid compound), mention may in particular be made of the following resins: α-pinene, β-pinene, dipentene or polylimonene or C5 cut homopolymers or copolymers, for example C5 cut/styrene copolymer or C5 cut/C9 cut copolymer, that can be used by themselves or in combination with plasticizing oils, such as for example MES or TDAE oils.

### II.5—Preparation of the Rubber Compositions

The filling compositions are manufactured in suitable mixers, using two successive preparation steps well known to those skilled in the art, namely a first, thermomechanical working or mixing step (called the “non-productive” step) at high temperature, up to a maximum temperature of between 110° C. and 190° C., preferably between 130° C. and 180° C., followed by a second, mechanical working step (called the “productive” step) up to a lower temperature, typically below 110° C., for example between 40° C. and 100° C., during which finishing step the crosslinking system is incorporated.

The process for preparing a filling composition includes for example at least the following steps:
during the first (“non-productive”) step, more than 50 phr of a filler A, the particles of which are nanoparticles with an average size (by weight) of less than 500 nm, and more than 70 phr of a filler B, the particles of which are microparticles having a median size (by weight) of greater than 1 μm, are incorporated into a diene elastomer by thermomechanically mixing all the ingredients, one or more times, until a maximum temperature of between 110° C. and 190° C. is reached;
the mixture is cooled down to a temperature below 100° C.;

the crosslinking system is then incorporated during the second (“productive”) step; and
everything is mixed until a maximum temperature below 110° C. is reached.

To give an example, the non-productive phase is carried out in a single thermomechanical step during which all the necessary base constituents (diene elastomer, reinforcing filler A and, if necessary, coupling agent, non-reinforcing filler B and plasticizing system) are firstly introduced into a suitable mixer, such as a standard internal mixer, and then, secondly, for example after one to two minutes of mixing, the other additives, optional covering agents or complementary processing aids, with the exception of the crosslinking system, are introduced. The total mixing time in this non-productive phase is preferably between 1 and 15 minutes.

After the mixture thus obtained is cooled, the crosslinking system is then incorporated in an external mixer, such as an open mill, maintained at low temperature (for example between 40° C. and 100° C.). All the ingredients are then mixed (during the productive phase) for a few minutes, for example between 2 and 15 minutes.

The crosslinking system is preferably a vulcanization system based on sulphur and an accelerator. It is possible to use any compound that can act as a vulcanization accelerator for diene elastomers in the presence of sulphur, in particular those chosen from the group formed by 2-mercapobenzothiazyl disulphide (abbreviated to MBTS), N-cyclohexyl-2-benzothiazyl sulphrnamide (abbreviated to CBS), N,N-dicyclohexyl-2-benzothiazyl sulphrnamide (abbreviated to DCBS), N-tert-butyl-2-benzothiazyl sulphrnamide (abbreviated to TBBS), N-tert-butyl-2-benzothiazyl sulphrnimide (abbreviated to TBSI) and mixtures of these compounds. Preferably, a primary accelerator of the sulphrnamide type is used.

Various known secondary accelerators or vulcanization activators, such as zinc oxide, stearic acid, guanidine derivatives (in particular diphrnylguanidine), etc., may be added to this vulcanization system during the first, non-productive step and/or during the productive step. The sulphur content lies, for example, between 0.5 and 3.0 phr, and that of the primary accelerator between 0.5 and 5.0 phr.

The final composition thus obtained can then be calendered, for example in the form of a sheet, or else extruded, for example to form a rubber strip that can be used as filling material for filling cavities present on the surface of the treads of tires.

The invention relates to the tires described above both in what is called the “green” state (i.e. before curing) and in what is called the “cured” or vulcanised state (i.e. after vulcanization).

### III. EXAMPLES OF IMPLEMENTATION OF THE INVENTION

### III.1—Preparation of the Compositions

The procedure for the following trials was the following: The reinforcing filler A (silica or carbon black), the non-reinforcing filler B, the coupling agent in the presence of silica, the diene elastomer and the various other ingredients, with the exception of the vulcanization system, were introduced in succession into an internal mixer (final fill factor: about 70% by volume), the initial barrel temperature of which was about 60° C. The mixture was then thermomechanically worked (non-productive phase) in one step, which lasted in total about 3 to 4 minutes, until a maximum “drop” temperature of 165° C. was reached.

The mixture thus obtained was recovered, cooled and then sulphur and a sulphmamide-type accelerator incorporated thereinto on a mixer (homogenizer-finisher) at 30° C., all the ingredients being mixed (in the productive phase) for a suitable time (for example between 5 and 12 minutes).

The compositions thus obtained were then calendered either in the form of rubber sheets (2 to 3 mm in thickness) or thin rubber sheets in order to measure their physical or mechanical properties, or were extruded in the form of a sheet in order to build tires, as for example indicated in the aforementioned Patent Application EP 1 065 075.

### III.2—Rubber Tests and Tire Running Tests

The purpose of the following trials was to demonstrate the improvement in grip on wet ground of passenger vehicle tires thanks to the filling of cavities present on the surface of their treads with a filling composition formulated in accordance with the invention.

### Trial 1:

Three rubber compositions were prepared as indicated above, two being formulated in accordance with the invention (denoted by C-1.2, C-1.3) and one not in accordance with the invention (denoted by C-1.1). These three compositions were based on silica as reinforcing filler A and further included, as regards the compositions formulated according to the invention, more than 70 phr of chalk as non-reinforcing filler B.

Listed in Table 1 are the contents of the various constituents (expressed in phr, where phr means parts by weight per one hundred parts of elastomer). The measured values of the mechanical properties of these compositions are given in Table 2.

This table shows for the filling compositions formulated in accordance with the invention, on the one hand, an increase in modulus and in Shore A hardness and, on the other hand, a decrease in the elongation at break. However, unexpectedly these modifications appear to be moderate as regards the large amount (75 or 110 phr) of non-reinforcing filler used. Such a compromise in properties suggests that these compositions used as filling material ought not to modify the mechanical behaviour of the tread substantially, while still providing more rapid wear than that of the rubber compounds constituting the base matrix of the tread and of its tread pattern elements.

Moreover, cracking tests were carried out on the three compositions, by observing the propagation under tension of a crack initiator produced in a composition test specimen. These tests revealed no difference between the filling compositions formulated according to the invention and the control composition, and they thus demonstrate the good crack resistance of the compositions formulated according to the invention despite the presence of a high content of filler B.

From this it may be deduced that the filling compositions tested here, based on silica and a high content of chalk as non-reinforcing filler, are capable of having a particularly favourable compromise of properties between the intended differential wear and the absence of cracking.

### Trial 2:

Trial I above was repeated, replacing, as reinforcing filler A, silica with carbon black.

To do this, four rubber compositions were prepared as indicated above, three being formulated in accordance with the invention (denoted by C-2.2, C-2.3 and C-2.4) and one not in accordance with the invention (denoted by C-2.1). The filling compositions formulated according to the invention furthermore contain more than 70 phr of chalk as non-reinforcing filler B.

Listed in Table 3 are the amounts of the various products (expressed in phr). The mechanical properties of the compositions are given in Table 4.

This table shows that, for the filling compositions formulated in accordance with the invention, there is, on the one hand, an increase in modulus and in Shore A hardness and, on the other hand, a decrease in the elongation at break. However, these changes remain moderate, even for a very high increase in the chalk content (a twofold increase between compositions C-2.2 and C-2.4). Cracking tests, carried out as previously in the case of trial 1, showed no appreciable difference between the compositions formulated according to the invention and the control composition, once again attesting to the good crack resistance of the compositions formulated according to the invention despite the presence of a high content of filler B.

Such properties confirm the previous results and suggest that the compositions formulated according to the invention ought to be able to fulfil the function of filling material (sufficient wear without the risk of cracking) without substantially affecting the mechanical behaviour of the tread.

### Trial 3:

The tread grip of passenger vehicle tires having a radial carcass, of 195/65 R15 size (speed index H), was analysed in accordance with the tests in section I-4.

Treads were conventionally manufactured, in all respects in the same way except for the presence or absence, on their surface, of cavities filled with the filling composition. The constituent composition of the tread itself was a rubber composition reinforced with silica, with a formulation identical to that of composition C-1.1 described above.

A control tire (denoted by P-I.1) had empty cavities (i.e. cavities not filled with the filling material), 2 mm in depth, on the surface of the tread pattern elements.

Other tires not in accordance with the invention (denoted by P-1.2) or in accordance with the invention (denoted by P-1.3, P-1.4 and P-1.5), were prepared with cavities present on the surface of the treads. These cavities consisted of incisions oriented along the transverse direction (i.e. perpendicular to the circumferential direction) of the tread, with a width of about 2 mm, a length of 1.5 cm and a depth of 8 mm (total thickness of the tread pattern element). A single incision was made in each elementary block of the tread pattern. These cavities were filled with a filling material with a base formulation identical to that of composition C-2.1 tested above, but furthermore including respectively 50, 100, 200 and 300 phr of chalk as non-reinforcing filler B.

The corresponding tires, denoted by P-1.1, P-1.2, P-1.3, P-1.4 and P-1.5 respectively, were mounted on a passenger vehicle in order to undergo the grip tests described in section 1-4 above (tests A.1 and A.2). The particular test conditions were the following: Citroën vehicle model “C5” (front and rear tire pressure: 2.2 bar); the tested tires were mounted at the front of the vehicle; ambient temperature: 25° C.

The results of the tests carried out on these tyres are given in Table 5.

This table shows that the braking distances of the tires in accordance with the invention, that is to say those in which the filling material comprises more than 70 phr of filler B (chalk), are in all cases shorter than those of the control tires (performance indices greater than 100). The presence of cavities on the surface of the tread, filled with the compositions formulated according to the invention, therefore enable the grip on wet ground of the tires to be substantially improved.

### Trial 4:

The above running trials were carried out again with tires and cavities of the same dimensions, these cavities this time being oriented along the longitudinal (circumferential) direction of the tread.

The control tire P-2.1 had cavities 2 mm in depth on the surface of the tread pattern elements, these cavities not being filled with the filling composition.

Tire P-2.2 according to the invention had cavities filled with a carbon-black-based composition with a formulation identical to that of composition C-2.1 above, and including, in a preferred embodiment, between 100 and 300 phr of non-reinforcing filler B (more precisely, 150 phr of chalk). The shape of these cavities was the same as that described in Trial 3. A single incision was made in each elementary tread pattern block.

The tires were mounted on the same passenger vehicle before being firstly subjected to a running test on a very twisty road circuit, for about 15 000 km, until a tread wear factor of 50% was obtained. After this, the tires thus worn were subjected to the grip tests described in section 1-4 above (tests A-2 and B).

The results of the tests are given in Table 6.

This table shows that, after such a prolonged running test (50% worn tread), the grip was still improved by 15% to 20%, depending on the test carried out, in the case of the tire in accordance with the invention compared with the control tire.

This clearly demonstrates the capability of the filling material in the cavity to withstand the various types of pounding suffered during a prolonged running test.

In other words, the invention makes it possible to create tread patterns in which the cavities filled with the filling composition have the capability of being self-regenerated while the tires are running, thus ensuring the longevity of the intended grip performance.

The invention also applies to the case of cavities that are not present on the surface of the treads in the unworn state but incorporated into the bulk of said treads and intended to be flush with the surface thereof at a subsequent stage after running for a first time.

TABLE 1

| Composition No: | C-1.1 | C-1.2 | C-1.3 |
|---|---|---|---|
| S-SBR (1) | 70 | 70 | 70 |
| BR (2) | 30 | 30 | 30 |
| filler A (3) | 80 | 80 | 80 |
| filler B (4) | 0 | 75 | 110 |
| coupling agent (5) | 6.4 | 6.4 | 6.4 |
| carbon black (6) | 6 | 6 | 6 |
| oil (7) | 33 | 33 | 33 |
| ZnO (8) | 2.5 | 2.5 | 2.5 |
| stearic acid (9) | 2 | 2 | 2 |
| antioxidant (10) | 1.9 | 1.9 | 1.9 |
| DPG (11) | 1.5 | 1.5 | 1.5 |
| sulphur | 1.1 | 1.1 | 1.1 |
| accelerator (12) | 2 | 2 | 2 |

(1) Oil-extended solution SBR (content expressed as dry SBR): 25% styrene; 58% 1, 2 polybutadiene units and 23% trans-1,4 polybutadiene units (T_{g} = −24° C.);
(2) BR with 4.3% 1, 2 units; 2.7% of trans units and 93% of cis-1,4 units (T_{g} = −106° C.);
(3) filler A: “Zeosil 1165 MP” silica from Rhodia, of the “HD” type (BET and CTAB: about 160 m²/g);
(4) filler B: chalk, “Omya BLS” brand from Omya;
(5) TESPT coupling agent (“Si69” from Degussa);
(6) N234 carbon black (ASTM grade);
(7) total MES oil (including SBR extender oil): “Catenex SNR” from Shell;
(8) zinc oxide (industrial grade from Umicore);
(9) stearine (“Pristerene 4931”, from Uniqema);
(10) N-1,3-dimethylbutyl-N-phrnylparaphrnylenediamine (Santoflex 6-PPD from Flexsys);
(11) diphrnylguanidine (Perkacit DPG from Flexsys);
(12) N-cyclohexyl-2-benzothiazyl sulphrnamide (Santocure CBS from Flexsys).

TABLE 2

| Properties | C-1.1 | C-1.2 | C-1.3 |
|---|---|---|---|
| Shore A | 70.8 | 75 | 77.2 |
| MA10 | 6.7 | 8 | 8.95 |
| AR | 528 | 470 | 425 |

TABLE 3

| Composition No: | C-2.1 | C-2.2 | C-2.3 | C-2.4 |
|---|---|---|---|---|
| SBR (1) | 75 | 75 | 75 | 75 |
| SBR (2) | 25 | 25 | 25 | 25 |
| filler A (3) | 85 | 85 | 85 | 85 |
| filler B (4) | 0 | 75 | 110 | 150 |
| oil (5) | 12 | 12 | 12 | 12 |
| ZnO (6) | 2.5 | 2.5 | 2.5 | 2.5 |
| stearic acid (7) | 0.5 | 0.5 | 0.5 | 0.5 |
| antioxidant (8) | 1.9 | 1.9 | 1.9 | 1.9 |
| sulphur | 1.7 | 1.7 | 1.7 | 1.7 |
| accelerator (9) | 1.6 | 1.6 | 1.6 | 1.6 |

(1) emulsion SBR extended with 37.5% by weight of aromatic oil (23.5% de styrene; 16% 1,2 polybutadiene units and 72% trans-1,4 polybutadiene units (T_{g} = −48° C. ));
(2) emulsion SBR extended with 37.5% by weight of oil (40% styrene; 16% 1,2 polybutadiene units and 72% trans-1,4 polybutadiene units (T_{g} = −30° C.));
(3) filler A: N375 carbon black;
(4) filler B: chalk, “Omya BLS” brand from Omya;
(5) total MES oil (including SBR extender oil): “Catenex SNR” from Shell;
(6) zinc oxide (industrial grade from Umicore);
(7) stearine (“Pristerene 4931”, from Uniqema);
(8) N-1,3-dimethylbutyl-N-phrnylparaphrnylenediamine (Santoflex 6-PPD from Flexsys);
(9) N-cyclohexyl-2-benzothiazyl sulphrnamide (Santocure CBS from Flexsys).

TABLE 4

| Properties | C-2.1 | C-2.2 | C-2.3 | C-2.4 |
|---|---|---|---|---|
| Shore A | 59.4 | 63 | 64.5 | 65.3 |
| MA10 | 3.9 | 4.4 | 4.6 | 4.9 |
| AR | 690 | 588 | 548 | 535 |

TABLE 5

| Tires | P-1.1 | P-1.2 | P-1.3 | P-1.4 | P-1.5 |
|---|---|---|---|---|---|
| Braking, ABS (u.r.) | 100 | 100 | 106 | 110 | 106 |
| Braking, locked | 100 | 100 | 102 | 105 | 103 |
| wheels (u.r.) | | | | | |

TABLE 6

| Tires | P-2.1 | P-2.2 |
|---|---|---|
| Braking, ABS (u.r.) | 100 | 120 |
| Transverse grip (u.r.) | 100 | 115 |

1. A tire having a tread, said tread being provided with a plurality of cavities, at least some of said cavities having a filling composition based on at least:
a diene elastomer;
more than 50 phr of filler (denoted filler A), the particles of which are nanoparticles having an average size (by weight) of less than 500 nm; and
more than 70 phr of filler (denoted filler B), the particles of which are microparticles having a median particle size (by weight) of greater than 1 □m.

2. The tire according to claim 1, the diene elastomer being selected from the group formed by: polybutadienes, natural rubber, synthetic polyisoprenes, butadiene copolymers, isoprene copolymers and blends of these elastomers.

3. The tire according to claim 1, wherein filler A comprises carbon black.

4. The tire according to claim 1, wherein filler A comprises an inorganic filler.

5. The tire according to claim 4, wherein the inorganic filler is silica.

6. The tire according to claim 1, wherein the amount of filler A is between 50 and 200 phr.

7. The tire according to claim 6, wherein the amount of filler A is between 60 and 140 phr.

8. The tire according to claim 1, wherein the amount of filler B is greater than 100 phr.

9. The tire according to claim 8, wherein the amount of filler B is between 100 and 500 phr.

10. The tire according to claim 1, wherein filler B has a median particle size of between 1 and 200 μm.

11. The tire according to claim 10, wherein filler B has a median particle size of between 5 and 100 μm.

12. The tire according to claim 1 wherein filler B is calcium carbonate or chalk.
